(19) United States
(12) Patent Application Publication
(10) Pub. No.: US 2005/0107925 A1
(43) Pub. Date: May 19, 2005

(54) Method and divece for outputting data relating to information of a motor vehicle

(76) Inventors: Holger Enigk, Rangsdorf (DE); Daniel Hoffmann, Sindelfingen (DE); Peter Hofmann, Grafenau (DE); Stefan Leboch, Pliezhausen (DE); Michaela Ludwig, Esslingen (DE); Gerhard Nagel, Gaertingen (DE); Katrin Pazda, Remshalden (DE); Siegfried Rothe, Denkendorf (DE); Kay Schattenberg, Stuttgart (DE); Christiane Steffens, Berlin (DE); Bernhard Straub, Starzach (DE); Hermann Von Hasseln, Esslingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/474,189

(22) PCT Filed: Feb. 13, 2002
(86) PCT No.: PCT/EP02/01485

(30) Foreign Application Priority Data
Apr. 6, 2001 (DE) 101 17 410.1

(51) Int. Cl. G06F 17/00

(52) U.S. Cl. 701/1; 307/10.1

(57) ABSTRACT

In a method for outputting data relating to user selectable information regarding a motor vehicle, a plurality of user selectable options relating to the information are represented, and data relating to the selected option is output. At least one context-dependent profile is defined, and a set of options determined by the profile is generated. Data are output as a function of the profiles and options.

This application claims the priority of German patent document 101 17 410.1, filed Apr. 6, 2001 (PCT No. PCT/EP02/01485) filed Feb. 13, 2002), the disclosure of which is expressly incorporated by reference herein.

### BACKGROUND AND SUMMARY OF THE INVENTION

The invention relates to a method and apparatus for outputting data providing information regarding a motor vehicle to a user of the motor vehicle.

International Patent Document WO 98/34812 discloses a multimedia information and control system for a motor vehicle, in which the user selects the information of interest to him from a defined global set. Various options relating to the information are then offered, from which he can select at least one option and cause the respective data to be output. Furthermore, an operator control function which corresponds to the data that are output can be executed.

One object of the invention is to provide an improved method and apparatus of the generic type in which operating convenience for the user is increased and operating safety and traffic safety are improved.

This and other objects and advantages are achieved by the method and apparatus, according to the invention, in which the type and number of the options generated with respect to the information is determined and the respective data are output, as a function of at least one context-dependent profile, thus providing the user with fast and simple access to data which are more wide ranging in that they describe the individual information more closely.

As used herein, the word “information” designates a generic classification or heading under which various data can be grouped, for example “windshield wiper”. The data relating to particular information comprises assigned details which are stored in a memory and which can be output in different ways for the user: in the case of “windshield wiper”, for example, an introduction video for operator control or a brief audio explanation of the interval levels.

The context-dependent profile relates to the characterization of at least one secondary factor in the interaction between the vehicle, the vehicle user and the environment (for example the user's age). By reference to the context dependent profile, the options which are associated with the “information” (e.g., windshield wipers) are conditioned in such a way that from a total set of options, only those options which are assigned to the context-dependent profile are generated.

Furthermore, by using the context-dependent profile it is also possible to output data automatically, without the user's previously having selected an option. By means of the context-dependent profile the number of generated options from which the user can make a selection and the outputting of the data are determined in such a manner that a clearly organized and user-compatible representation is made possible. Thus, when an item of information relating to the motor vehicle is requested, a subset of the entire set of data relating to this information is selected as a function of the profiles. (The subset can of course also correspond to the entire data set.) The selected data are output in a way which is particularly data-optimized for the user. As a result, the sequence of selecting data and outputting data is shortened, depending on the context.

The invention also makes a contribution both to convenience and to safety. For example, when a vehicle display lights up, the user is automatically offered an explanation of this vehicle display as a function of the profile, by reason of appropriate data being output. The user is thus immediately informed, without having to think about the explanation or even perform awkward control operations. Likewise it possible to provide the user with selective proposals as a function of the profiles and to instruct him about vehicle functions which are suitable to use in a specific situation.

It is advantageous if an operator control function whose use is proposed with the data which is output, is triggered as a function of the profiles and options. As a result, the operating convenience is increased further, because the user does not need to search for the triggering means which are assigned to this operator control function by virtue of the fact that the proposed operator control function is triggered in an easy way which is optimized as much as possible with respect to time. Such direct triggering of the operator control function, without previous interrogation of the user makes it possible to trigger the operator control function much more reliably in particular in driving situations for which timing is critical. Alternatively, direct triggering of the operator control function may be provided. In this case, as a function of the profiles, a corresponding option is defined, said option being selected and then bringing about indirect triggering of the operator control function. An example of direct or indirect triggering occurs if the driver selects the reverse gear on his vehicle, and as a result, either an electrically movable rear roller blind is retracted (direct triggering) or the retraction of the rear roller blind is proposed as an option (indirect triggering).

One advantageous embodiment of the invention selects, for a particular user, a context-dependent profile based on the assignment of that user to a defined user group. As a result, convenience is increased further in that a specific, group related information requirement is fulfilled. For example, the assignment of the user to a user group takes into account whether he or she is already familiar with the vehicle or the make of vehicle. For example, a first user group may comprise users for which the vehicle or the make of vehicle is new, and a second user group may comprise experienced users. If, for example, a user is assigned to the first user group, a specific context dependent profile is defined, bringing about an additional, explanatory outputting of data, for example relating to operator control elements. Alternatively or additionally, a brief explanation on the vehicle and its operator control elements is possible when the user is assigned to the first user group. The described assignment to user groups is carried out, for example, during visits for servicing of the vehicle. Thus, when the vehicle is handed back the “new user” profile can then be defined. On one of the subsequent visits to the workshop it is then possible to define the “experienced users” group.

A further possibility of a predefinable user group is to select an “interested user” profile which, for example with respect to predefinable vehicle reactions, supplies data in the form of explanations or technical explanations on vehicle functions. By assigning the user to a user group for the disabled it is possible to output data as a function of the profile in order to support the user in specific situations. For example, given an assignment of the user to a “restricted hearing” user group, as a function of the profiles, supplementary visual data are output if according to standard practice an operator control element provides audible feedback in the vehicle.

A user can also be assigned to more than one user group, so that more than one profile is assigned for him, preferably with different priorities assigned to different profiles. If a signal for representing options and/or for outputting data (below for the sake of simplification we only refer to the outputting of options or data) from two or more profiles is present, the options or data are output in correct order and as a function of the priority of the profile. Here, for example, the options or data with the highest priority are output immediately and additionally an option which the user can select in order to cause the further options or data to be output is illustrated.

It is also possible to define separate profiles for a plurality of users, for example for a user who drives the vehicle, a user who is a front seat passenger, or a user who is sitting in the rear of the vehicle. In a profile which is defined for the driver of the vehicle, functions relating, for example, to driving safety are provided, while in a profile defined for the rear-seat passengers, audio and multimedia functions are provided, for example. In this manner, the operating reliability and thus the traffic safety are increased by the context-dependent profile for the driver of the vehicle. Similarly, for a rear-seat passenger the operating convenience is increased, and comprehensive information about the operator control functions which are available is provided. In addition it is also thus possible to define further profiles, for example it is possible to provide a specific profile for a service technician with a representation of options and/or outputting of data on the diagnostics of the vehicle.

A further advantageous embodiment of the invention selects a context-dependent profile for a predefinable vehicle environment. Here, a user is informed about changes which have occurred in the course of his journey by presenting options and/or data which permit the user to prepare for changed conditions on his route, as a function of the profiles. For example, it is possible for him to obtain information about operator control functions which are suitable for the new conditions and to trigger these functions. Thus, in the case of a road in poor condition which is stored as an attribute in the digital road map of the vehicle, it is possible to present options as a function of the profiles and/or to output data relating to the operator control elements of a ride level controller (which sets the ground clearance of the motor vehicle). Furthermore, it is possible, for example, to define a country-specific profile. When it is detected that a national border has been crossed, information about country-specific traffic regulations are provided as a function of the profiles. A conventional device for locating the position of the vehicle is used, for example, to identify the border crossing.

In a further refinement of the invention, context dependent profiles are defined with respect to the type of vehicle. As a result, a user is informed about changes which occur when the type of vehicle which he uses at a particular time changes. If the user changes, for example, from his previous vehicle model of his make of vehicle to a newer model, only options or data which relate to operator control elements which have changed or are new in comparison to his previously used vehicle are issued to him. This applies in an analogous way, for example, to retrofits or software updates of vehicles. In each case the differences between the current vehicle and the vehicle which is known to the user is determined first, and only those options or data which are associated with this difference for the user are output to the user as a function of the profiles. As a result, by virtue of the profiles, the user is informed about the possibilities which the currently used vehicle provides. These context-dependent profiles are preferably defined for a user individually according to a type of vehicle. It is possible, for example, for a “first user” profile to be present which explains innovations only a single time, while a “second user” profile explains these changes within a specific time period whenever a journey is begun.

It is very advantageous to define context dependent profiles which output options and/or data as a function of at least one current vehicle variable, such as for example, currently measured sensor data or vehicle system states such as the heating level of the seat heating system or the range of the vehicle with the currently available quantity of fuel which is determined by the trip computer. As a result, a vehicle user can be informed particularly quickly about specific situations because, data corresponding to the situation indicated by the vehicle variables is issued to him, as a function of the profiles. For example, options or data relating to a TCS (Traction Control System) can be output if the wheels spin during the process of driving off. It is also possible to output, as a function of the profiles, instructions on “cutting free” (by the user briefly switching off the TCS during the process of driving off), by virtue of the fact that the operator control element for switching off the TCS is pointed out and/or direct triggering—i.e. deactivation—with or without previous interrogation of the user is brought about. In the case of a flat tire or an accident it is possible, for example, to issue options or data on the correct behavior in emergency situations and/or on the position of the warning triangle in the vehicle. The vehicle variables can also be transmitted from outside the vehicle, for example in wireless fashion by XFCD (“Extended Floating Car Data”). It is thus possible to transmit into the vehicle sensor data about weather conditions on the route ahead. The user is then issued with options or data as a function of the profiles such that the user can set an air conditioning system in his vehicle in a way which is advantageous for these conditions.

A further advantageous embodiment of the invention provides for a plausibility check for a control operation which is carried out by the user, with the options and/or the data being output as a function of the result of the plausibility check. This increases the operator control reliability and increases the convenience because a user is offered information about an operator control function or its operator control element as a function of the profile if he makes an operator control error or if an algorithm detects an operator control problem. As a result, it is possible, for example when there is multiple use of the operator control elements for main beam and/or indicator lights within a short period of time while it is raining at the same time, to offer and/or issue data on the operator control of the windshield wiper, in particular on how to switch it on, as options for selection.

In a further configuration of the invention, vehicle variables and/or operator control operations are stored in a memory, which is initially interrogated before options are represented and/or data is output as a function of the profiles. If values relating to preceding vehicle variables or operator control operations are stored in the memory, these values are checked to determine whether they are to be taken into account in the representation of the current options and/or in the outputting of the current data. This further increases operating convenience because a rapid selection of options and/or data is matched individually to the user. As it were, a “memory” is provided by virtue of the fact that conclusions can be drawn relating to a current operator control operation, for example from analyzing preceding operator control operations. In the case of operator control steps which the user usually makes, it is thus possible to suppress a representation of information and outputting of data. The classification of operator control problems or the categorization of current vehicle variables is also improved by virtue of the fact that, for example, operator control steps which are specific to a user are detected and no longer classified as an operator control problem and explanatory data is output. Such a recognition can be achieved, for example, by using the methods of “artificial intelligence” (such as a neural network). By checking of values stored in the memory it is also possible to make modifications to the currently defined, context-dependent profile itself and/or retrieve and subsequently define a different context dependent profile.

It is advantageous if at least part of an operating manual for the motor vehicle is represented as information relating to the motor vehicle. A method suitable for this purpose is described, for example, in the German Patent Application DE 199 59 755.3-21 whose content is included herein by reference. In this method, a current equipment variant of the motor vehicle is determined in a preceding step and a second database is generated from a first database as a function of this determined variant, this second database comprising only information on the operator control for the current equipment variant of the motor vehicle. In this way, a continuously updated information state relating to the motor vehicle and its operator control elements is ensured.

The device according to the invention for processing and outputting data relating to information regarding a motor vehicle or its operator control elements comprises a display for representing options relating to the information (referred to below for short as first output means), a display for the user to select at least one option (referred to below for short as selection means), a display for outputting data relating to the selected option (referred to for short below as second output means) and a processing unit which generates, by reference to at least one defined, context-dependent profile, a number of options that are characterized by the profile and which processing unit outputs data as a function of the profiles and options. This processing unit may be embodied, for example, as a vehicle computer (a processing unit which is arranged in the vehicle). However, it can also be implemented by providing additional functions to a unit which is already present in the vehicle—for example a control device.

The first output means and/or the second output means may be, for example, display units of conventional design such as LCD (Liquid Crystal Display), or may be presented on the windshield (Head Up Display). It is advantageous here to embody the display unit as a function of the set of characteristics of the options and/or data (both of these are referred to below as data set). For example, a small data set may be output by means of a display which is already present in the vehicle, while a relatively large data set is output by means of a further relatively large display which is mounted on the dashboard or in the center console. In addition, further possibilities for displaying options and/or data are available. The outputting of the options and data can also depend on what technical equipment a vehicle has. For example, when a suitable display fails, it is possible to suppress the outputting of certain data (for example video sequences forming a short introduction to the vehicle for a new user). Of course, it is also possible to provide a joint display for outputting the options and data. In order to integrate the first and/or second output means with the selection means, a conventional touch-sensitive display (touch screen) is preferably provided.

Alternatively or additionally, the selection means may be embodied as a voice operated controller, such as is already used today in motor vehicles, permitting the driver to concentrate his visual attention on the events on the road. Furthermore, the selection means may be embodied as a manual operator control element of conventional design, for example, in the form of a joystick, or as a combined rotary/pushbutton knob which has in each case a different number of latching positions depending on the number of options for the information. Such an operator control element is also already present in many vehicles (for example for controlling a navigation device), and can be used advantageously. Further possible operator control systems may be provided.

In order to output the options or the selected data it is possible to provide means of a conventional design, for example audible outputs, such as an audio system, or haptic output (for example a force feedback operator control element, an opposing force being exerted at said operator control element when it is used). The means which is used for inputting and/or outputting may also be defined in a variable fashion as a function of the profiles, for example a visual output is replaced by an audible output as soon as the vehicle exceeds a defined limiting speed. Furthermore, the data which are output can be further processed and fed to other systems, in particular assistance systems in a motor vehicle.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic block circuit diagram of an embodiment of the device for outputting data relating to information regarding a motor vehicle;

FIG. 2 shows a schematic block circuit diagram of a further embodiment of the device;

FIG. 3 shows a plan view of an embodiment of the device;

FIG. 4 shows, by way of example, an image which is represented on a display unit, and is generated by the device in a basic state;

FIG. 5 shows, by way of example, an image which is represented on a display unit, and is generated by the device in a state with a preselected option; and

FIG. 6 shows, by way of example, an image which is represented on a display unit, and is generated by the device in a state with output data.

### DETAILED DESCRIPTION OF THE DRAWINGS

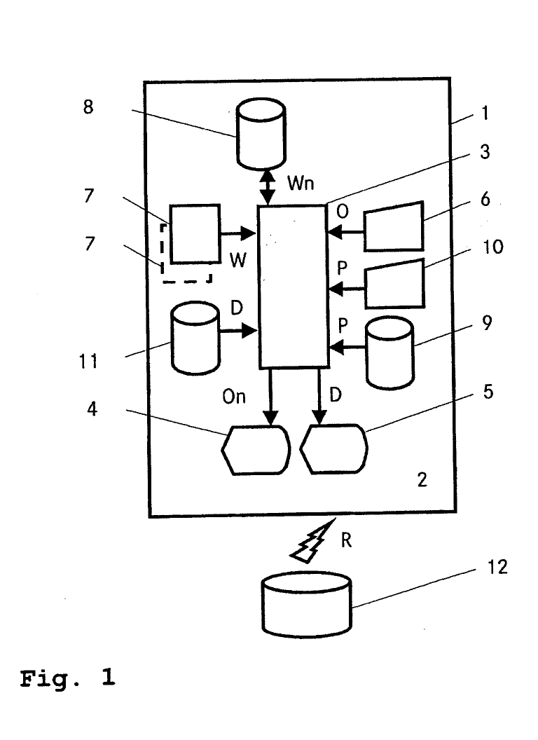

FIG. 1 shows a motor vehicle 1 with a device 2 for outputting data (D) with a processing unit 3. The device 2 comprises a means 4 for representing options (On) relating to the information (I) (referred to below for short as options output means 4), and a means 5 for outputting data (D) relating to the selected option (O) (referred to below for short as data output means 5). The two output means 4 and 5 are, for example, two displays which are arranged at a distance from one another. Alternatively, both output means 4 and 5 can be formed by a display. As a further alternative or additionally, an audible output is provided for the output means 4 and/or 5.

Furthermore, the processing unit 3 has a means 6 (referred to below for short as selection means 6) by which the user can select at least one option (O). The selection means 6 is embodied as a separate unit, for example, as a voice operated controller. Additionally or alternatively, a manual operator control element of conventional design may be provided, such as for example a joystick or a combined rotary/pushbutton knob, which has a large number of different latched positions depending on the number of options (On) for the information. As a further alternative it is possible to provide a unit which detects body movements or facial expression of the user, classified them and assigns them to a corresponding operator control request, for which the requested operator control operation is then carried out.

The processing unit 3 is supplied with values (W) from at least one component 7, such as a vehicle-mounted sensor which measures the current speed, or a control unit which is provided for setting possibilities of the vehicle seat. However, it is also possible to transmit values in a wireless fashion into the vehicle, for example from other vehicles and/or from local transmission devices arranged at the edge of the road pavement. Furthermore, a unit 8 for storing values (Wn) such as, for example, sensor data and/or operator control operations is provided (referred to below as storage unit 8). The storage unit 8 may be embodied as part of the usual peripheral components of the processing unit 3 with a conventional design.

Furthermore, at least one context-dependent profile (P) is selected from a memory 9 by at least one profile selection means 10, and fed to the processing unit 3. The profile selection means 10 may provide a switch, for example a rotary or pushbutton switch, which is suitable for this. The user places the switch in a switch position which is provided for it and which is sensed by the processing unit 3, after which it retrieves the context-dependent profile or profiles (P) which is selected by the user from the memory 9 and allocates them to the user.

Alternatively, the profile selection means 10 is connected to the starting device of the engine as a fingerprint sensor (detection of the “fingerprint” of the user). When the user initiates an engine starting procedure, he is identified by the profile selection means 10. Then, at least one context dependent profile (P) which is provided for the user is retrieved from the memory 9 and defined for him. Likewise, it is possible to provide a specific interface of the processor unit 3 as the profile selection means 10, to which interface, for example, a customary diagnostic device for defining a context dependent profile (P) can be connected.

Alternatively or additionally, an electronic data carrier can be provided for the combination of memory 9 and profile selection means 10, the user carrying said data carrier, for example a driver-specific chip card, on him and introducing it into a device which is connected to the vehicle. The user-specific values which are evaluated by the processing unit 3 and bring about the selection of a context-dependent profile (P) which is suitable for the user are stored on the chip card. The electronic data carrier can also be used for storing other values. For example, the data carrier can also be provided for storing values (Wn) such as, for example, sensor data and/or operator control operations of the user.

Alternatively or additionally, the memory 9 can also be provided outside the vehicle for example, in a service center (a central processing unit with a database which can be used in a wireless fashion by subscribers to a respective service). A context-dependent profile (P) which is provided for the user is transferred from the service center into the vehicle in a wireless fashion if it is detected in this control center that a transceiver unit (“radio key”) which is carried by the user initiates vehicle starting procedure. Alternatively or additionally, the service center is also used to store vehicle-related values (Wn) such as, for example, sensor data and/or operator control operations of the user.

The selection of the information (I), the type and number of options (On) generated with respect to the information (I) and the outputting of the respective data (D) are controlled by the context-dependent profile (P) by means of the processing unit 3. The data (D) which are to be output are selected from a database 11 as a function of profiles and/or options, read and output using the output means 5. Depending on the type and design of the device 2, the database 11 is integrated in the motor vehicle 1. Alternatively or additionally, data from an external database 12 can be read by the processing device 2 via wireless transmission R. This external database 12 can be provided in the service center described above.

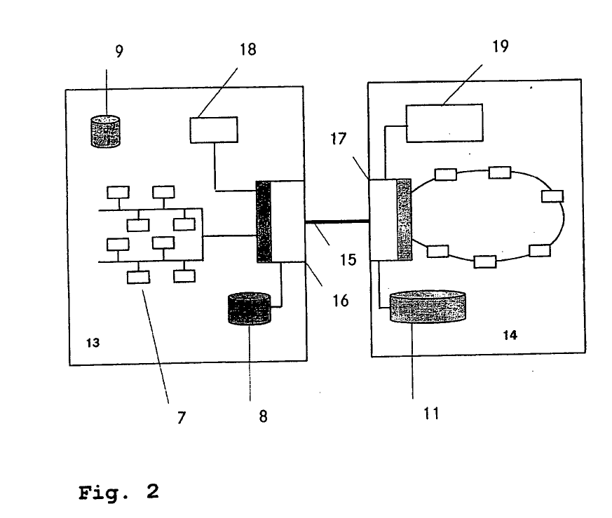

FIG. 2 illustrates a further embodiment of the device 2 for outputting data (D) relating to the information (I). The device 2 comprises two separate networks 13, 14, which are embodied as units of network nodes that are each connected to a plurality of transmission lines. This distributed design divides the functional units of the device 2 (shown in FIG. 1) into the network 13 in which the values (W) of the component 7 are collected and conditioned, while storage, conditioning and outputting of data (D) is carried out by the network 14. The networks 13, 14 are connected to one another by a transmission line 15. In order to connect the two networks 13, 14 to the transmission line 15, the gateway network node 16 is provided in the network 13 and the gateway network node 17 is provided in the network 14. As is schematically illustrated in FIG. 2, the two networks 13, 14 have different architectures and are thus configured for different requirements. The network 13 has a tree structure and comprises components 7, the storage unit 8, the memory 9 and an associated display unit 18, while the network 14, which has a ring structure and is suitable particularly for transmitting large amounts of data, comprises the database 11 and an associated, large-format display unit 19.

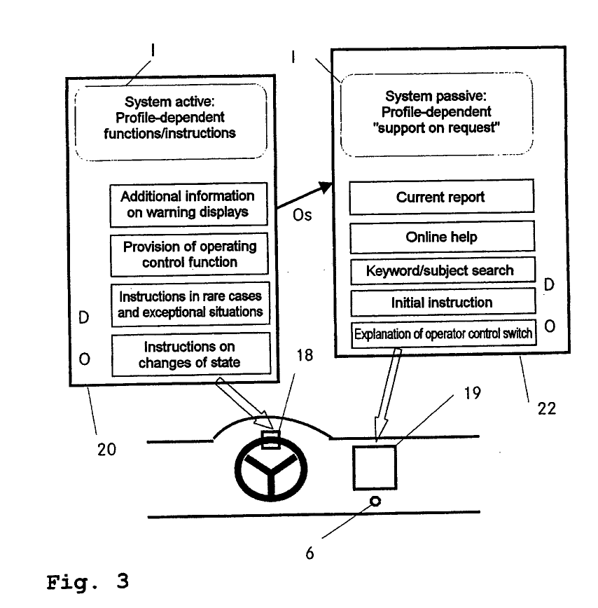

FIG. 3 is a plan view of an embodiment of the device 2 in the dashboard of the motor vehicle 1, including a display unit 18, the selection means 6 for selecting options (On) and the display unit 19. The processing unit 3 causes data (D) relating to information (I) to be represented on the display unit 18, as a function of profiles and/or options. At the same time, the information (I) designates a global term which can include various types of data (D). As is illustrated in block 20, explanations of warning displays and changes of states of the motor vehicle 1 as well as of exceptional situations and suitable operator control functions are output on the display unit 18 by the processing unit 3. When there is a more wide ranging information request relating to data (D) which has already been output in the display unit 18 in the form of brief information, further data (D) is output as a detailed explanation in the display unit 19 as a function of the profiles. The display units 18, 19 are appropriately embodied in terms of their size, type and arrangement in this respect.

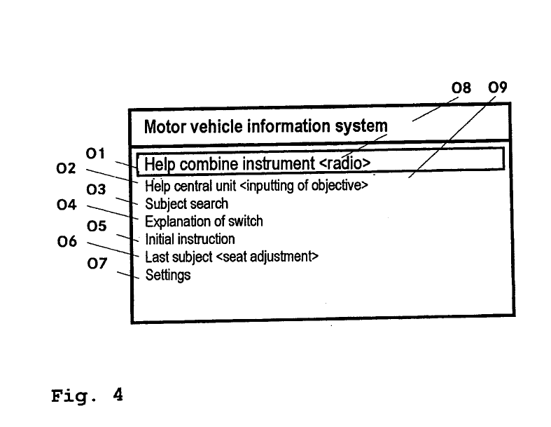

Additionally or alternatively, options (O) relating to the information (I) for the outputting of data are represented on the display unit 18, as illustrated by way of example in FIG. 4. A respective option (Os) for the outputting of the data (D) which describe the respective information is selected by operating the selection means 6. When there is a direct request for information (I) by the user via the manual operated control element 6, corresponding data (D) are output on the display unit 19. This data comprise, as shown in block 22, an online help, a keyword/subject search feature, an initial instruction feature and an explanation of operator control switches, as shown in FIG. 3.

FIG. 4 shows by way of example an image which is represented on the output means 4 or 5 and generated by the device 2 as a function of the profiles when the device 2 is in a basic state. In this state, the user can request data (D) directly as a function of the profiles. As shown in FIG. 4 as a function of the context dependent profile, the user is provided, with the options 01 to 07 relating to the information (I) “motor vehicle information system”. The user can retrieve explanatory data (D) and/or further options (O) relating to the multipurpose instrument and to the central unit by selecting corresponding options 01, 02 by using the selection means 6. Here, a further option 08, 09 relating to the two first options 01, 02, which can be selected by selection, is already defined. The option 01 is already selected as a function of the profiles. Furthermore, the user can selectively search for subjects on which he desires further explanations by selecting the option 03 “subject search”. If the user selects the option 04 “explanation of switch”, he can cause data (D) and/or further options (O) relating to individual operator control elements to be output directly. The selection of the option 05 “initial instruction” by the user causes data (D) and/or further options (O) to be output which are advantageous for the user if he is using the motor vehicle for the first time. By selecting the option 06 “last subject” data which the user had already requested once at an earlier time is output to the user. Selecting the option 07 “settings” provides the user with information on the device according to the invention itself.

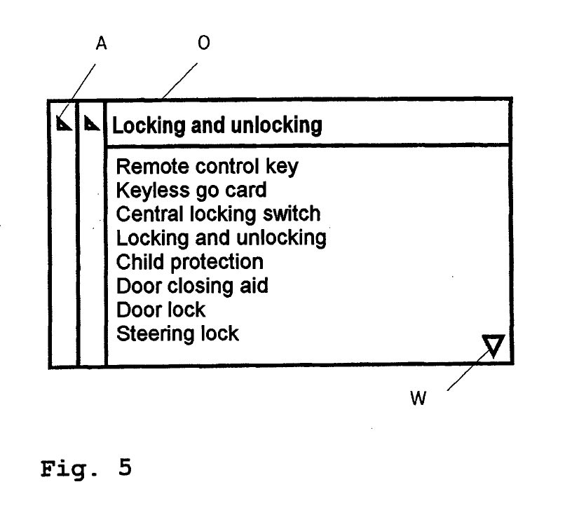

FIG. 5 shows by way of example a further image which is represented on the output means 4 or 5. The image represents to the user that the device 2 is in a state in which an option (O) has already been selected. In this state, the user can cause the corresponding data (D) to be output automatically as a function of the profiles, and as a function of options by selecting the respective option (O). Likewise, a number of symbols A indicate to the user how many options 0 have already been selected. Here, the respectively generated images are depicted one on top of the other as a hierarchical structure. The direct representation of such an image as a function of the profiles according to the invention avoids the tedious selection process which would otherwise precede a representation of this image. Directly selecting a symbol A causes the respective image to be represented directly in the hierarchical structure. A symbol (W) indicates to the user that further options (O) have been generated, and these can be “scrolled through” by selecting the symbol (W).

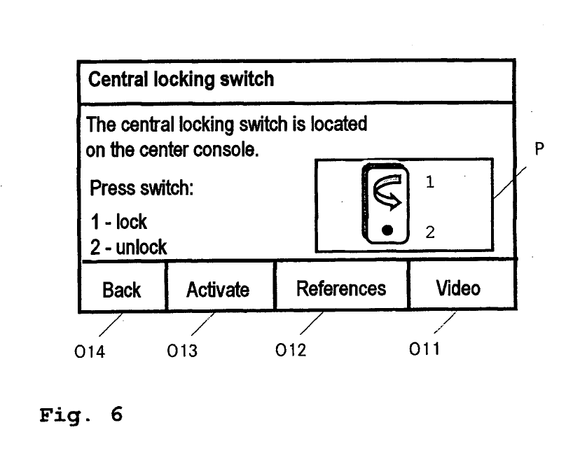

FIG. 6 shows by way of example an image which is represented on the display unit 5. This image is generated by the device 2 if it is in a state with data (D) which have been output. As is apparent in FIG. 6, these data (D) comprise a pictogram (P), which has been obtained from the operating manual of the motor vehicle 1, and explanatory text. Selecting the option 011 causes further data (D) to be output. Selecting the option 012 causes thematically related data (D) to be represented as options (O) for outputting. Selecting the option 013 causes the operator control function which is explained by the data (D) to be triggered. Selecting the option 014 causes the image generated by a preceding processing step to be represented.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-15. (canceled)

16. A method for outputting to a vehicle user, data relating to information concerning a motor vehicle, said method comprising:
defining at least one context-dependent profile;
generating user selectable options for at least one item of information, which options are characterized by the at least one context-dependent profile; and
outputting data relating to a selected option, said data being selected from an entire data set as a function of the at least one profile.

17. The method as claimed in claim 16, wherein an operator control function which corresponds to the data which are output is executed as a function of the profiles and options.

18. The method as claimed in claim 16, wherein a particular profile is provided for a predefinable user group.

19. The method as claimed in claim 16, wherein a particular profile is provided for a predefinable vehicle environment.

20. The method as claimed in claim 16, wherein a particular profile is provided based on the type of vehicle.

21. The method as claimed in claim 16, wherein the options are presented and/or the data are output as a function of current vehicle parameters.

22. The method as claimed in claim 16, further comprising:
performing a plausibility check for a control operation that is carried out by the vehicle user; and
presenting the options or outputting the data are output as a function of a result of said check.

23. The method as claimed in claim 16, further comprising:
storing preceding vehicle variables and/or preceding control operations; and
presenting options or outputting the data, as a function of stored values.

24. The method as claimed in claim 16, further comprising:
processing the data further; and
feeding the data to other systems in the motor vehicle.

25. The method as claimed in claim 16, wherein at least part of a motor vehicle operating manual is presented as information.

26. A device for outputting to a vehicle user, data relating to information concerning a motor vehicle, said device comprising:
a processing unit which generates, by reference to at least one defined context-dependent profile, a plurality of options which are associated with the at least one profile;
interface means for representing the options generated by the processing unit;
means for a user selecting at least one option from among the options generated by the processing unit and represented by the interface means; and
means for outputting data relating to a selected option, as a function of the at least one profile.

27. The device as claimed in claim 26, further comprising at least one display unit for outputting data as a function of a data set which characterizes it.

28. The device as claimed in claim 26, wherein the selection means comprises a voice input.

29. The device as claimed in claim 26, wherein the selection means comprises a manual operator control element.

30. The device as claimed in claim 26, wherein means are provided for audibly outputting options and/or data.

31. A method for selectively outputting vehicle related information to a vehicle user, comprising:
providing an overall data set that includes data relating to said vehicle, said data being accessible according to a hierarchical classification structure, including a plurality of items of information, each of said items of information having associated therewith selected data from said overall data set, said selected data being selectively displayable according to a plurality of selectable options associated with said information;
defining a plurality of context dependent profiles whose content is based on parameters characterizing at least one of said vehicle, its operation and said vehicle user;
in response to designation of an item of information, generating a set of selectable options from among said plurality of selectable options, based on a particular context dependent profile; and
outputting data relating to a selected option, as a function of the particular option.
